(19) United States
(12) Patent Application Publication
(10) Pub. No.: US 2015/0352817 A1
(43) Pub. Date: Dec. 10, 2015

(54) MULTILAYER HEAT-SHRINK PLASTICS MATERIAL FILM

(71) Applicant: Sleever International Company, Morangis (FR)

(72) Inventor: Eric Fresnel, Paris (FR)

(21) Appl. No.: 14/827,756

(22) Filed: Aug. 17, 2015

Related U.S. Application Data
(63) Continuation of application No. 14/054,278, filed on Oct. 15, 2013.

(30) Foreign Application Priority Data
Oct. 26, 2012 (FR) 1260271

(51) Int. Cl. B32B 27/08; B65D 71/08; B32B 27/36; B32B 27/30; B32B 27/32

(52) U.S. Cl. CPC B32B 27/08; B32B 27/302; B32B 27/32; B32B 27/36; B65D 71/08; B32B 2250/05; B32B 2250/24; B32B 2250/40; B32B 2255/10; B32B 2270/00; B32B 2274/00; B32B 2307/736; B32B 2307/746; B32B 2439/60

(57) ABSTRACT

The invention provides a multilayer heat-shrink film, comprising a central first layer made up of a first composition comprising at least one polyolefin; intermediate second layers made up of a second composition and covering respective faces of the first layer, the second composition comprising a styrene-based resin; and outer third layers made up of a third composition and covering respective ones of the intermediate second layers, the third composition comprising at least one polyester.

### CROSS REFERENCE TO RELATED APPLICATION

This application is a continuation of U.S. Application Ser. No. 14/054,278, filed Oct. 15, 2013, which claims foreign priority to French Application No. 1260271, filed Oct. 26, 2012, each of which is hereby incorporated by reference in their entirety.

### TECHNICAL FIELD

The invention relates to a multilayer heat-shrink plastics material film, preferably obtained by coextrusion and presenting low density, and more particularly a film adapted to making heat-shrink sleeves for covering articles made of polyethylene terephthalate (PET), such as bottles.

### BACKGROUND

Document EP 2 008 811 discloses a heat-shrink plastics material film comprising a central layer mainly containing polyolefin resin, outer layers containing a polyester resin, and intermediate layers including a polyethylene resin including a glycidyl methacrylate compound.

### SUMMARY

One object of the invention is to provide a film with reinforced cohesion between the layers.

Another object of the invention is to provide a film having a spectrum in the near infrared that is adapted, e.g. either to be close to that of the PET container covered with such a film, or else on the contrary to be specific so as to enable the sleeve made using such a film to be distinguished from other sleeves.

### DETAILED DESCRIPTION

The invention provides a multilayer heat-shrink film, comprising:

a central first layer made up of a first composition comprising at least one polyolefin;
intermediate second layers made up of a second composition and covering respective faces of the first layer, the second composition comprising a styrene-based resin; and
outer third layers made up of a third composition and covering respective ones of the intermediate second layers, the third composition comprising at least one polyester.

This thus produces a multilayer film comprising the following respective layers stacked one on another:

an outer third layer;
an intermediate second layer;
a central first layer;
an intermediate second layer; and
an outer third layer.

The use of a styrene-based resin for the intermediate layers serves to reinforce the cohesion between the layers. In particular, when a sleeve is made from the film of the invention, the styrene-based resin for the intermediate layers makes it possible to avoid the layers separating from one another during heat-shrinking of the sleeve on a bottle or on some other medium.

The materials used make it possible to obtain a low density film capable of ensuring that sleeves made from such a film float.

It is thus easy to recycle such sleeves. When recycling PET bottles, bottles carrying their sleeves are ground up and then immersed in a pool. The PET pellets from the bottles then sink, while the pellets coming from the sleeves float on the surface of the pool. It is thus easy to separate the PET from the sleeves and avoid pellets coming from the sleeves remaining with the PET pellets in the remainder of the recycling cycle, given that the pellets from the sleeves run the risk of degrading the recycling of PET pellets.

The materials used are selected so that the film preferably presents specific gravity of less than 1.

Preferably, the film is made up solely of the central first layer, the intermediate second layers, and the outer third layers.

In a preferred embodiment of the invention, the resin of the second composition comprises at least one thermoplastic elastomer based on a styrene-block copolymer, in particular a first polystyrene-polybutadiene-polystyrene block copolymer.

Preferably, the polystyrene-polybutadiene-polystyrene first block copolymer comprises 70% by weight styrene units relative to the total weight of the first block copolymer.

By way of example, the first copolymer is Styroflex 2G66 (registered trademark).

Preferably, the resin of the second composition comprises, in addition to:

a) the first polystyrene-polybutadiene-polystyrene block copolymer having 70% by weight of styrene units relative to the total weight of the first block copolymer;
one or more ingredients selected from:
b) a second polystyrene-polybutadiene-polystyrene block copolymer having less than 70% by weight of styrene units relative to the total weight of the second block copolymer; and
c) a polystyrene.

Under such circumstances, the compounds a), b), c) are in the resin at respective weight proportions lying in the respective ranges a): [30%, 80%]; b): [0%, 70%]; c): [0%, 30%]; the sum of the three proportions being equal to 100%.

In a particular aspect of the invention, the first composition comprises one or more polyolefins selected from:

d) a first linear low-density polyethylene;
e) a second linear low-density polyethylene;
f) a high-density polyethylene;
g) a metallocene-catalyzed linear low-density polyethylene; and
h) a propropylene.

Advantageously, the polyolefins d), e), f), g), and h) are then present in the first composition at respective weight proportions lying in the following respective ranges d): [20%, 40%]; e): [30%, 60%]; f): [20%, 40%]; g): [30%, 70%]; and h): [0%, 40%]; the sum of the weight proportions being equal to 100%.

In yet another particular aspect of the invention, the third composition comprises one or more compounds selected from:

i) a 1,4 cyclohexanedimethanol modified polyethylene terephthalate;
j) a polyester or a copolyester having a low glass transition temperature;
k) a neopentyl glycol modified polyethylene terephthalate; and
l) a crystallizable polyester.

Preferably, the compounds i), j), k), and I) are then present in the third composition in respective weight proportions lying in the following respective ranges i): [0%, 99%]; j): [0%, 40%]; k): [0%, 99%]; and I): [0%, 20%]; the sum of the weight proportions being equal to 100%.

Advantageously, the compound j) is a diethylene glycol modified polyethylene terephthalate.

Advantageously, the compound I) is polyethylene terephthalate.

Advantageously, the third composition further comprises at least one slip agent such as a silicate or a mixture of talc and a fatty acid amide or a mixture of a plurality of fatty acid amides.

Preferably, the central first layer has thickness lying in the range 55% to 70% of the total thickness of the film, the intermediate second layers together have thickness lying in the range 15% to 30% of the total thickness of the film, and the outer third layers together have thickness lying in the range 15% to 30% of the total thickness of the film.

In another particular aspect of the invention, each of the outer third layers comprises a compound having an emission spectrum in the near infrared that is centered on a wavelength lying in the range 1400 nanometers (nm) to 1900 nm.

Advantageously, the compound enables a sleeve made from such a film to be easily distinguished from sleeves made using other films. When sorting bottles optically, the near infrared spectrum of a sleeve made from such a film is necessarily different from the spectrum of sleeves made using other films, such that the presence of the sleeve does not interfere with sorting PET bottles.

Advantageously, the compound is a varnish covering the free surfaces of the two outer third layers.

Alternatively, the compound is incorporated in the third composition in such a manner that the two outer third layers have an emission spectrum in the near infrared centered on a wavelength lying in the range 1400 nm to 1900 nm. Advantageously, the compound comprises polyethylene terephthalate. Also advantageously, the compound comprises a glycol modified polyester or an acid modified polyester.

In a variant, the compound is selected to give the film a near infrared spectrum that is close to that of the PET container covered using such a film. While sorting bottles optically, the near infrared spectrum of a sleeve made from such a film does not interfere with the near infrared spectrum of PET bottles covered in said film, such that the presence of the sleeve does not impede sorting PET bottles.

1. A multilayered shrink film characterized in that it comprises:
a first central layer formed from a first composition having at least one polyolefin,
second intermediate layers formed from a second composition and covering respectively one of the faces of the first layer, the second composition containing a styrene based resin,
third external layers formed from a third composition and covering respectively one of the two intermediate layers, the third composition containing at least one polyester.

2. The film according to claim 1, wherein the resin of the second composition contains at least one thermoplastic elastomer based on a block copolymer of styrene.

3. The film according to claim 2, wherein the block copolymer of styrene is a block copolymer of polystyrene-polybutadiene-polystyrene.

4. The film according to claim 3, wherein the block copolymer of polystyrene-polybutadiene-polystyrene comprises 70% by weight of the styrene radicals in relation to the total weight of the block copolymer.

5. The film according to claim 4, wherein the resin of the second composition comprises, besides the following compound:
a) the block copolymer of polystyrene-polybutadiene-polystyrene, as first block copolymer, which comprises 70% by weight of the styrene radicals in relation to the total weight of the block copolymer, one or more of the compounds chosen from among:
b) a second block copolymer polystyrene-polybutadiene-polystyrene having less than 70% by weight of styrene radicals as compared to the total weight of the second block copolymer,
c) a polystyrene.

6. The film according to claim 5, wherein the compounds a), b), c) are present in the resin by the following mass ratios comprised in the following respective ranges: a) [30%; 80%], b) [0%; 70%], c) [0%; 30%], the sum of the three ratios being equal to 100%.

7. The film according to claim 1, wherein the first composition contains one or more polyolefins chosen from among:
d) a first low-density linear polyethylene,
e) a second low-density linear polyethylene,
f) a high-density polyethylene,
g) a low-density linear polyethylene catalyzed by metallocene,
h) a polypropylene.

8. The film according to claim 7, wherein the polyolefins d), e), f), g) and h) are present in the first composition by the respective weight ratios comprised in the respective ranges: d) [20%; 40%], e) [30%; 60%], f) [20%; 40%], g) [30%; 70%], and h) [0%; 40%], the sum of the weight ratios being equal to 100%.

9. The film according to claim 1, wherein the third composition contains one or more compounds chosen from among:
i) a polyethylene terephtalate modified with 1,4-cyclohexane dimethanol,
j) a polyester or a copolyester with a low glass transition temperature,
k) a polyethylene terephtalate modified with neopentyl glycol, and
l) a crystallizable polyester.

10. The film according to claim 9, wherein the compounds i), j), k) and I) are present in the third composition by the respective weight ratios comprised in the respective ranges i) [0%; 99%], j) [ 0% ; 40%], k)[0%; 99%], and I) [0%; 20%], the sum of the weight ratios being equal to 100%.

11. The film according to claim 9, wherein compound j) is a polyethylene terephtalate modified with diethylene glycol.

12. The film according to claim 9, wherein compound I) is a polyethylene terephtalate.

13. The film according to claim 9, wherein the third composition furthermore contains at least one lubricating agent such as a silicate or a mixture of talc and a fatty acid amide or a mixture of several fatty acid amides.

14. The film according to claim 1, wherein the first central layer has a thickness between 55 and 70% of the total film thickness, the two intermediate layers together having a thickness between 15 and 30% of the total film thickness and the third external layers having together a thickness between 15 and 30% of the total film thickness.

15. The film according to claim 1, wherein the third external layers each contain a compound having a near infrared emission spectrum centered on a wavelength between 1400 and 1900 nanometers.

16. The film according to claim 15, wherein the compound is a varnish covering the free surfaces of the two third external layers.

17. The film according to claim 15, wherein the compound is incorporated in the third composition such that the two third external layers have a near infrared emission spectrum centered on a wavelength between 1400 and 1900 nanometers.

18. The film according to claim 17, wherein the compound comprises a polyethylene terephtalate.

19. The film according to claim 17, wherein the compound comprises a polyester modified with glycol or a polyester modified by an acid.
